(19) United States
(12) Patent Application Publication
(10) Pub. No.: US 2006/0291078 A1
(43) Pub. Date: Dec. 28, 2006

(54) Lens barrel and image pickup apparatus

(75) Inventors: Yoshifumi Mitani, Osaka (JP); Naohiko Hayashi, Osaka (JP); Naoki Hashimoto, Toyokawa-shi (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/474,679

(22) Filed: Jun. 26, 2006

(30) Foreign Application Priority Data
Jun. 28, 2005 (JP) JP2005-187971

(51) Int. Cl. G02B 7/02

(52) U.S. Cl. 359/819

(57) ABSTRACT

A lens barrel and an imaging apparatus are provided that can definitely detect the positions of a plurality of lens groups, do not require high accuracy components, has a high reliability, and is inexpensive. In a lens barrel provided with imaging optical systems with two or more lens groups and driving devices that independently drive the respective lens groups, a lens barrel constituted so that it has a detected member that is attached to one of the lens groups among said lens groups, and said lens group to which said member to be detected is attached moves in conjunction with the drive of the lens group to which said member to be detected is not attached.

This application is based on Japanese Patent Application No. 2005-187971 filed on Jun. 28, 2005, in Japanese Patent Office, the entire content of which is hereby incorporated by reference.

### TECHNICAL FIELD

The present invention relates to lens barrels and image pickup apparatuses.

### BACKGROUND

Conventionally, with some lens barrels of imaging optical systems etc., an optical system is constituted using a plurality of lens groups, and each of these plural lens groups is driven independently. When driving independently each lens group in a plurality of lens groups in this manner, position detection of each lens group is made, and the control of variable power such as zooming, the control of focusing etc., and the control of stowing etc., of the collapsible lens are carried out. Mostly DC motors and pulse motors are used as the drive source for these controls. In the case of a DC motor, the amount of movement of the lens group is linked to the series of gears, and there is the method of detecting the position by an encoder that repeats light passage (not blocking) and light blocking by a photo-interrupter from the count of the encoder. Further, in the case of a pulse motor, there is the method of detecting the position by the number of pulses that have been given to the pulse motor.

In these controls, it is necessary to set a reference position in order to accurately know the absolute position. Conventionally, in general, a light cut-off plate was provided for each drive section in order to detect the reference position with good accuracy, and the reference position was detected when the light cut-off plate blocked the light of the photo-interrupter.

However, if a dedicated photo-interrupter is provided for each drive section, space for their installation is necessary thereby making the lens barrel larger in size, increasing the cost, and also increasing the current consumption.

In order to solve the above problems, a method has been proposed in which the photo-interrupter for detecting the reference position is shared among a plurality of lens groups, and separate detections are made in time sequence (see, for example, Patent Document 1).

Further, a method has been proposed (see, for example, Patent Document 2) in which the photo-interrupter for detecting the reference position is shared among a plurality of lens groups, and separate detections are made from the output voltage of the photo-interrupter by providing each of the plurality of lens groups with respective light cut-off plates and light attenuating plates.

Patent Document 1: U.S. Pat. No. 5,708,870

Patent Document 2: Japanese Laid-Open Patent Publication No. 2004-109934

However, in the method of Patent Document 1 described above, for example, when the power supply of the camera is switched ON, etc., even if an attempt is made to detect the position, at times it may not be possible to know the light cut-off plate of which lens group is cutting off the light of the photo-interrupter at that time.

Further, in the method of Patent Document 2, since the status is being detected by the change in the amount of light passing through the light attenuating plate, the accuracy control of different components such as the transmittance of light attenuating plates, the amount of light of the photo-interrupter or the sensitivity of the reception section, the threshold voltage of the comparator, etc., becomes stricter and the cost increases. In addition, the different components deteriorate due to changes caused by the passage of time, and hence it is likely to cause wrong detections.

### SUMMARY

In view of the above problems, an object of the present invention is to provide a lens barrel and an image pickup apparatus that definitely detects the positions of a plurality of lens groups, does not require high-accuracy components, has high reliability, and is inexpensive.

In view of forgoing, one embodiment according to one aspect of the present invention is a lens barrel, comprising:

a first lens group which is movable;

a first driving device for moving the first lens group along an optical axis;

a second lens group which is movable;

a second driving device for moving the second lens group along the optical axis;

a member to be detected which is fixed on the second lens group;

a detector for detecting the member to be detected; and

an interlock mechanism for interlocking the second lens group with a movement of the fist lens group.

According to another aspect of the present invention, another embodiment is an image pickup apparatus, comprising:

an imaging device;

a lens barrel for projecting an optical image on the imaging device; and

an controller which controls the imaging device and the lens barrel,

wherein the lens barrel comprises:

a first lens group which is movable;

a first driving device for moving the first lens group along an optical axis;

a second lens group which is movable;

a second driving device for moving the second lens group along the optical axis;

a member to be detected which is fixed on the second lens group;

a detector for detecting the member to be detected; and

an interlock mechanism for interlocking the second lens group with a movement of the fist lens group.

### BRIEF DESCRIPTION OF THE DRAWING

FIG. 1 is a cross-sectional diagram showing the state in the collapsed condition of the lens barrel according to a preferred embodiment of the present invention.

FIG. 2 is a cross-sectional diagram showing the state in the telephoto condition of the lens barrel according to a preferred embodiment of the present invention.

FIG. 3 is an explanatory diagram of the cam cylinder 22.

FIG. 4 is an assembly diagram of the CCD fixing tube 5 and the lens frame 13 of the third group optical system.

FIG. 5 is an explanatory diagram of the lens frame 12 of the second group optical system.

FIG. 6(a) is an external view diagram showing an example of a camera 10 provided with a lens barrel according to a preferred embodiment of the present invention. FIG. 6(b) is an external view diagram showing an example of a camera 10 provided with a lens barrel according to a preferred embodiment of the present invention.

FIG. 7 is a circuit block diagram of a camera 10 provided with a lens barrel according to a preferred embodiment of the present invention.

FIG. 8(a) is a schematic diagram for explaining the operations of the second group optical system and the third group optical system from the collapsed state to the imaging ready state in a preferred embodiment of the present invention.

FIG. 8(b) is a schematic diagram for explaining the operations of the second group optical system and the third group optical system from the collapsed state to the imaging ready state in a preferred embodiment of the present invention.

FIG. 8(c) is a schematic diagram for explaining the operations of the second group optical system and the third group optical system from the collapsed state to the imaging ready state in a preferred embodiment of the present invention.

FIG. 8(d) is a schematic diagram for explaining the operations of the second group optical system and the third group optical system from the collapsed state to the imaging ready state in a preferred embodiment of the present invention.

FIG. 8(e) is a schematic diagram for explaining the operations of the second group optical system and the third group optical system from the collapsed state to the imaging ready state in a preferred embodiment of the present invention.

FIG. 8(f) is a schematic diagram for explaining the operations of the second group optical system and the third group optical system from the collapsed state to the imaging ready state in a preferred embodiment of the present invention.

FIG. 9 is a flow chart for explaining the outline procedure of the operations of the second group optical system and the third group optical system from the collapsed state to the imaging ready state in a preferred embodiment of the present invention.

FIG. 10(a) a schematic diagram for explaining the operations of the second group optical system and the third group optical system from the imaging ready state to the collapsed state in a preferred embodiment of the present invention.

FIG. 10(b) a schematic diagram for explaining the operations of the second group optical system and the third group optical system from the imaging ready state to the collapsed state in a preferred embodiment of the present invention.

FIG. 10(c) a schematic diagram for explaining the operations of the second group optical system and the third group optical system from the imaging ready state to the collapsed state in a preferred embodiment of the present invention.

FIG. 10(d) a schematic diagram for explaining the operations of the second group optical system and the third group optical system from the imaging ready state to the collapsed state in a preferred embodiment of the present invention.

FIG. 11 is a flow chart for explaining the outline procedure of the operations of the second group optical system and the third group optical system from the imaging ready state to the collapsed state in a preferred embodiment of the present invention.

### DETAILED DESCRIPTION OF THE PREFERRED EMBODIMENT

Although in the following the present invention is described in detail using a preferred embodiment, the present invention shall not be restricted by this.

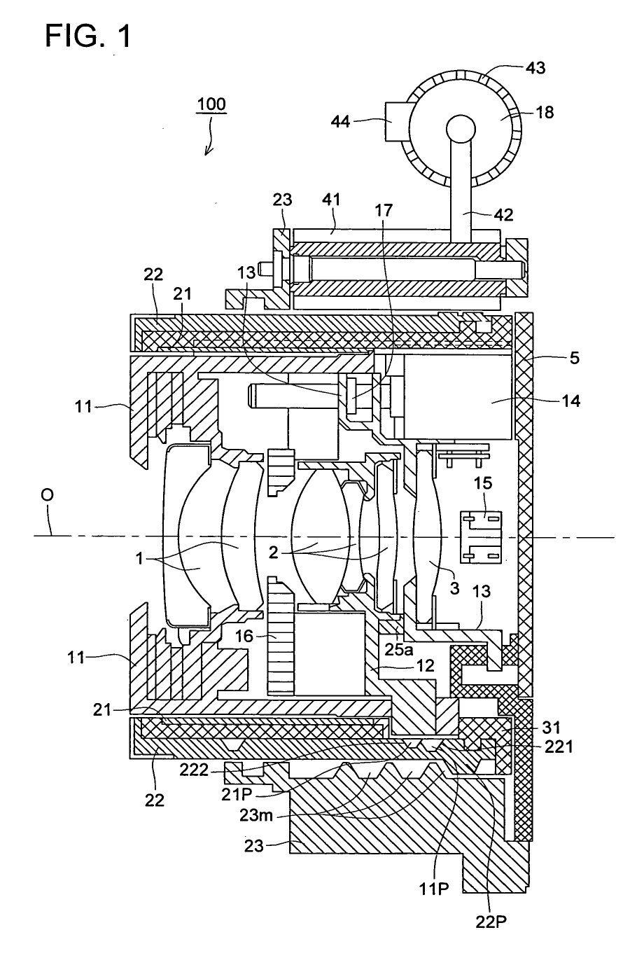

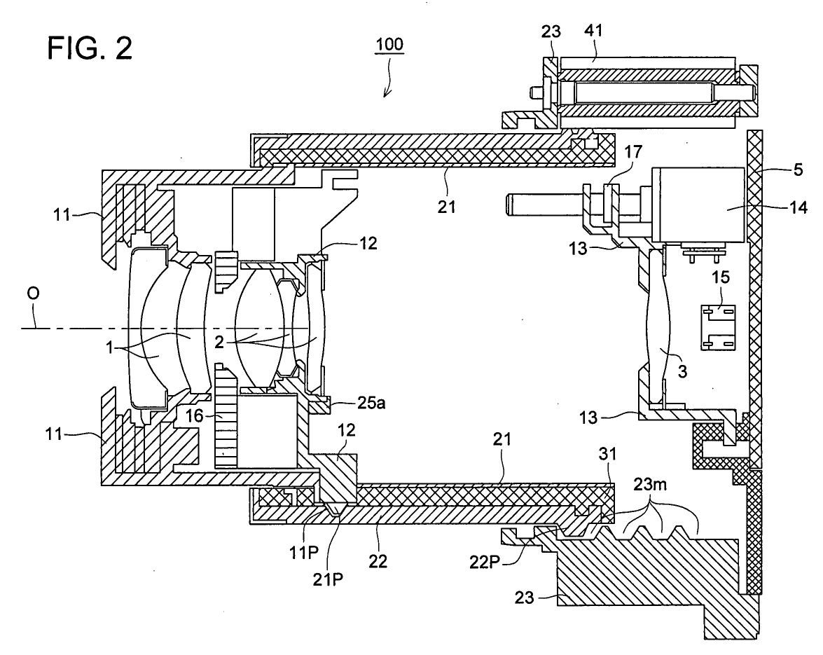

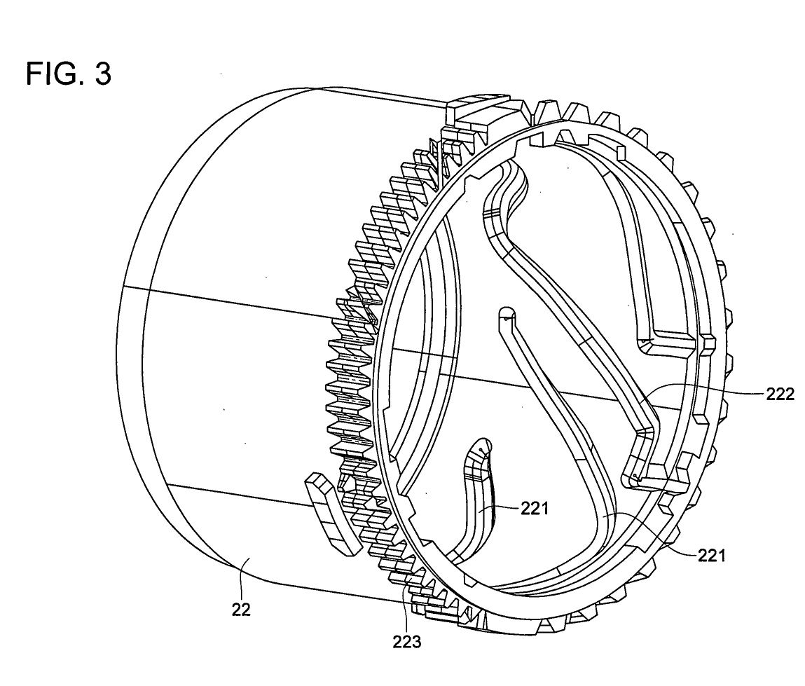

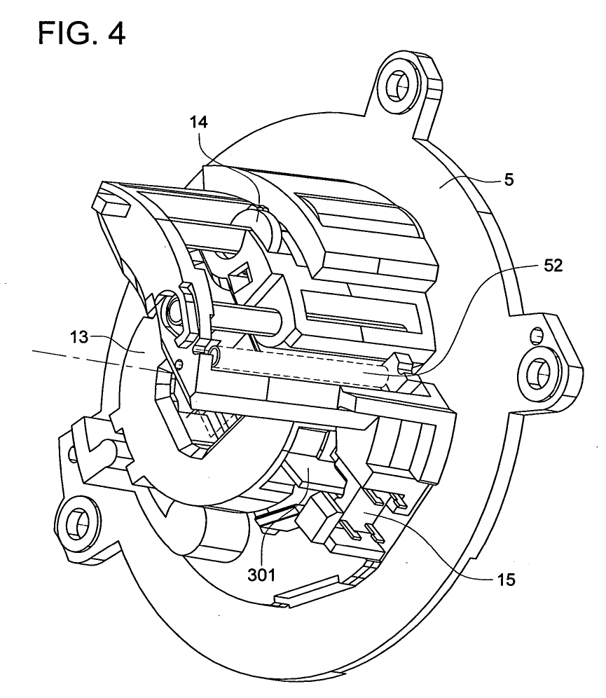

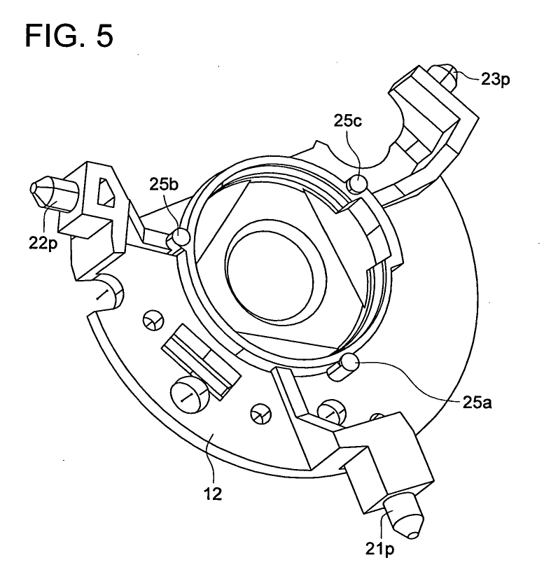

FIG. 1 is a cross-sectional diagram showing the state in the collapsed condition of the lens barrel 100 according to a preferred embodiment of the present invention, FIG. 2 is a cross-sectional diagram showing the state in the telephoto condition of the lens barrel 100. At the time of explaining FIG. 1, the explanatory diagram of the cam cylinder 22 in FIG. 3, the assembly diagram of the CCD fixing tube 5 and the lens frame 13 of the third group optical system of FIG. 4, and the explanatory diagram of the lens frame 12 of the second group optical system of FIG. 5 are also explained.

In FIG. 1, the numeric symbol 1 is the first group optical system, 2 is the second group optical system, 3 is the third group optical system, and the imaging optical system is constituted using these three group optical systems. The third group optical system 3 is the lens group to which the member to be detected of the present invention is attached, and the second group optical system 2 is the lens group to which the member to be detected of the present invention is not attached.

An optical filter, not shown in the figure, with an infrared cut-off filter and an optical low pass filter stacked and an imaging device are placed so that they are supported by the CCD fixing tube. A fixed tube 23 is affixed to the CCD fixing tube 5. A cam tube 22 is placed inside the fixed tube 23 so that it can rotate relative to the fixed tube 23, and is supported so that it can move along the optical axis O. A straight moving tube 21 is placed inside the cam tube 22.

A straight movement guide 31 is placed outside the straight moving tube 21, this straight movement guide 31 engages with a straight movement guide groove, not shown in the figure, formed in the fixed tube 23, and can move along with the cam tube 22, without rotating, in the direction of the optical axis O together with the movement of the cam tube 22 in the direction of the optical axis O. In the following explanations, the direction of movement towards the left in FIG. 1 is referred to as towards the object side, and the direction of movement towards the right in FIG. 1 is referred to as towards the image side.

The first group optical system 1 is supported by the first group optical system lens frame 11, and this first group optical system lens frame 11 is supported by the straight moving tube 21. Not only the cam pin lip of the first group optical system lens frame 11 engages with first cam groove 221 formed on the inside surface of the cam tube 22, but also a part of the first group optical system lens frame mates with the straight moving tube 21, and the straight movement in the direction of the optical axis O is being made by the rotation of the cam tube with respect to the fixed tube 23 and movement in the direction of the optical axis O.

The second group optical system 2 which is the lens group to which the member to be detected according to the present invention is not attached is supported by the second group optical system lens frame 12. FIG. 5 is an explanatory diagram of the lens frame 12 of the second group optical system 2, in which 25a, 25b, and 25c are the contacting parts, and 21p, 22p, and 23p are the cam pins. Not only a part of this second group optical system lens frame 12 engages with the fixed tube 23, but also the cam pin 21p that is either formed integrally with it or is implanted in it engages with the cam groove 222 formed on the inside surface of the cam tube 22, and is moved straight in the direction of the optical axis O due to the rotation and straight movement of the cam tube 22. Further, the aperture shutter unit 16 is fixed to this second group optical system lens frame 12. Also, the aperture shutter unit 16 need not be only one that has both an aperture and a shutter unit, but also can be one that has only an aperture, or only a shutter unit.

The cam pin 22p is either formed integrally with or is implanted in the cam tube 22, and is moved straight in the direction of the optical axis O being guided by the cam groove 23 formed on the inside surface of the fixed tube 23.

As is shown in FIG. 3, two types of cam grooves are formed on the inside surface of the cam tube 22, namely, the first group cam groove 221 that engages with the cam pin 21p formed in the straight moving tube 21, and the second group cam groove 222 that engages with the second group optical system lens frame 12, and zooming is done by moving the first group optical system 1 and the second group optical system 2 respectively to their desired positions.

The cam tube drive motor 18 is the driving device that drives the lens group to which the member to be detected according to the present invention is not attached. In this configuration, the cam tube drive motor 18 rotates the reduction gear column 42 by a screw section provided on its rotating shaft thereby driving the long gear 41 engaging with the reduction gear column 42 in the forward and reverse directions. Since this long gear 41 is engaged with the cam tube gear 223 provided on the cam tube 22, the forward and reverse rotations of the cam tube 22 are possible due to the rotation of the long gear 41. In this manner, by making the cam tube drive motor 18 rotate, it is possible to carry out zooming by moving the first group optical system 1 and the second group optical system 2 respectively to their desired positions.

In the present preferred embodiment, the cam tube drive motor 18 is a DC motor, and to detect the amount of rotation of the cam tube 22 that is rotated by the cam tube drive motor 18, an encoder 43 is provided at one end of the rotating shaft of the cam tube drive motor 18. The changes in the light passing through the encoder 43 are detected by the second photo-interrupter 44, obtaining pulse signals in synchronization with the rotation of the cam tube drive motor 18, and it is possible to detect the amount of movement of the second group optical system 2 that is driven in coupling with the cam tube 22. Further, although an example of using a DC motor is given in the present preferred embodiment, if a pulse motor is used, it is possible to detect the amount of movement of the second group optical system 2 from the number of pulses given to the pulse motor.

The change from the collapsed state shown in FIG. 1 of the lens barrel 100 from the telephoto state shown in FIG. 2 is made by driving the cam tube drive motor 18 placed outside the lens barrel and not shown in FIG. 2, which drives the long gear 41 due to the reduction gear column 42, causes the cam tube 22 to rotate relative to the fixed tube 23, and the cam tube 22 is pushed out being guided by the cam groove 23m in the fixed tube 23, and in addition, the straight moving tube 21 is pushed out to the prescribed position by the first group cam groove 221, the cam pin 21p, and the straight movement guide 31 formed on the inner surface of the cam tube 22, and the second group optical system lens frame 12 is pushed out to the prescribed position by the cam groove 22n formed on the inside surface of the cam tube 22, the cam pin 12p formed in the second group optical system lens frame 12, and the straight movement guide 31.

The third group optical system 3 which is a lens group to which a member to be detected according to the present invention is attached is supported by the third group optical system lens frame 13, and the configuration is such that this third group optical system lens frame 13 can be moved in the direction of the optical axis O during both zooming and focusing by the focusing motor 14 which is the driving device that drives the lens group to which a member to be detected according to the present invention is not attached, and is driven independently from the other lens groups.

The focusing motor 14 is the driving device that drives the lens group to which a member to be detected according to the present invention is attached. The rotating shaft of the focusing motor 14 is constituted as a lead screw with which a nut 17 is engaged. The nut 17 is prevented from rotating, and moves linearly in the direction of the optical axis due to the rotation of the rotating shaft of the focusing motor 14. In addition, the focusing motor 14 is a pulse motor, and the amount of movement of the nut 17 can be controlled by the number of pulses given to the focusing motor 14.

Explanation is given here about the third group optical system lens frame 13 using FIG. 4. In FIG. 4, the bias spring 52 is the interlock mechanism of the present invention, the first photo-interrupter 15 is the detector of the present invention, and the PI light cutoff section 301 is the member to be detected according to the present invention.

The third group optical system lens frame 13 is biased by the bias spring 52 so that it is separated from the imaging device towards the object side.

FIG. 4 shows the state in which the PI light cutoff section 301 formed integrally with the third group optical system lens frame 13 is inserted between the light emitting section and the light receiving section of the first photo-interrupter 15. In the present preferred embodiment, the PI light cutoff section 301 is judged to have passed the reference position when the front edge of the PI light cutoff section 301 (towards the front end of the lens barrel) passes the light flux between the light emitting section and the light receiving section of the first photo-interrupter 15. Further, it goes without saying that it is also possible to detect the other edge of the PI light cutoff section 301 or the opening section provided in the light cutoff section.

In the collapsed state shown in FIG. 1, the contacting part 25 of the second group optical system lens frame 12 comes into contact with the third group optical system lens frame 13 against the force of the bias spring 52 now shown in FIG. 1, and is pressing the second group optical system lens frame 12 towards the image side (towards the right in FIG. 1).

In the telephoto state shown in FIG. 2, the contacting part 25 of the second group optical system lens frame 12 is separated, the nut 17 that moves linearly due to the focusing motor 14 is in contact with the third group optical system lens frame 13 due to the pressing force of the bias spring 52, thereby determining the position of the third group optical system lens frame 13.

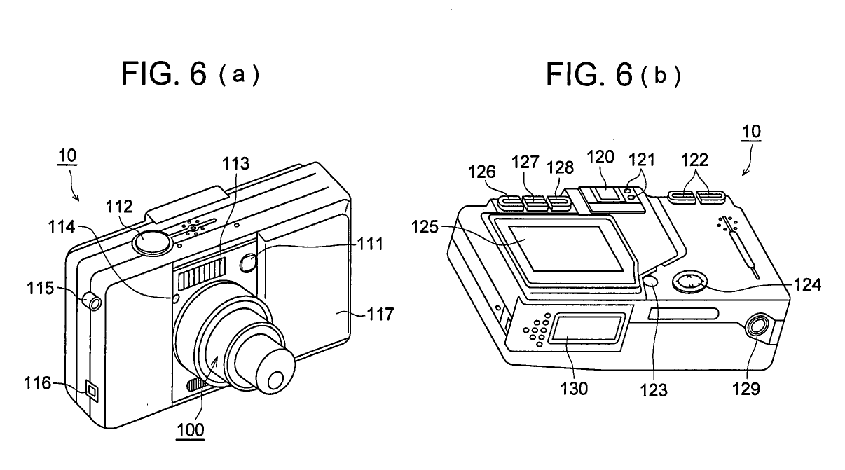

FIGS. 6(a) and 6(b) are external view diagrams showing an example of a camera 10 provided with a lens barrel 100 according to the preferred embodiment of the present invention. FIG. 6(a) is the perspective view of the front of the camera 10 and FIG. 6(b) is the perspective view of the back of the camera 10.

In FIG. 6(a), the numeric symbol 100 denotes the lens barrel described in the present preferred embodiment of the invention, inside which a zoom imaging optical system is enclosed. 111 is the viewfinder window, 112 is the shutter release button, 113 is the flash emission section, 114 is the sensor window for light adjustment, 115 is the strap attachment part, and 116 is the external input/output terminal (for example, USB terminal). Also, 117 is the slide barrier, and when it is in the open state, the lens barrel 100 is in the imaging ready state as is shown in the figure, and the lens barrel 100 collapses when this is moved slightly towards the closing side. In other words, the camera 10 goes into the starting state in combination with the opening and closing of the slide barrier 117.

When the shutter release button 112 is pressed up to its first stage, the camera 10 carries out the image preparation operations, that is, the camera 10 carries out the focusing operation and the exposure measurement operations, and when the shutter release button 112 is pressed up to its second stage, the photograph exposure operation is made.

In FIG. 6(b), 120 is the viewfinder eyepiece, 121 is a red and green display lamp that displays to the photographer the AF or AE information by lighting up or flashing. Also, 122 is the zoom button, by using which it is possible to zoom in and zoom out. Further, 123 is the Menu/Set button, 124 is the Select button and has 4-way switches, 125 is the image display section that displays images or other text information. Different types of menus are displayed in the display section 125 using the Menu/Set button 123, selected by the Select button 124, and confirmed by pressing the Menu/Set button 123. Also, 126 is the playback button used for reproducing the photographed images, 127 is the display button used for displaying or turning off the images or other text information displayed in the image display section 125, 128 is the erase button used for erasing images that have been photographed and recorded, 129 is the screw hole for mounting the camera on a tripod, and 130 is the battery/card cover. Inside the battery/card cover 130 are provided slots for the battery giving power supply to the camera and for a memory card for recording the photographed images, and it is possible to insert or remove here a battery and a card type memory card 65 not shown in the figure for recording.

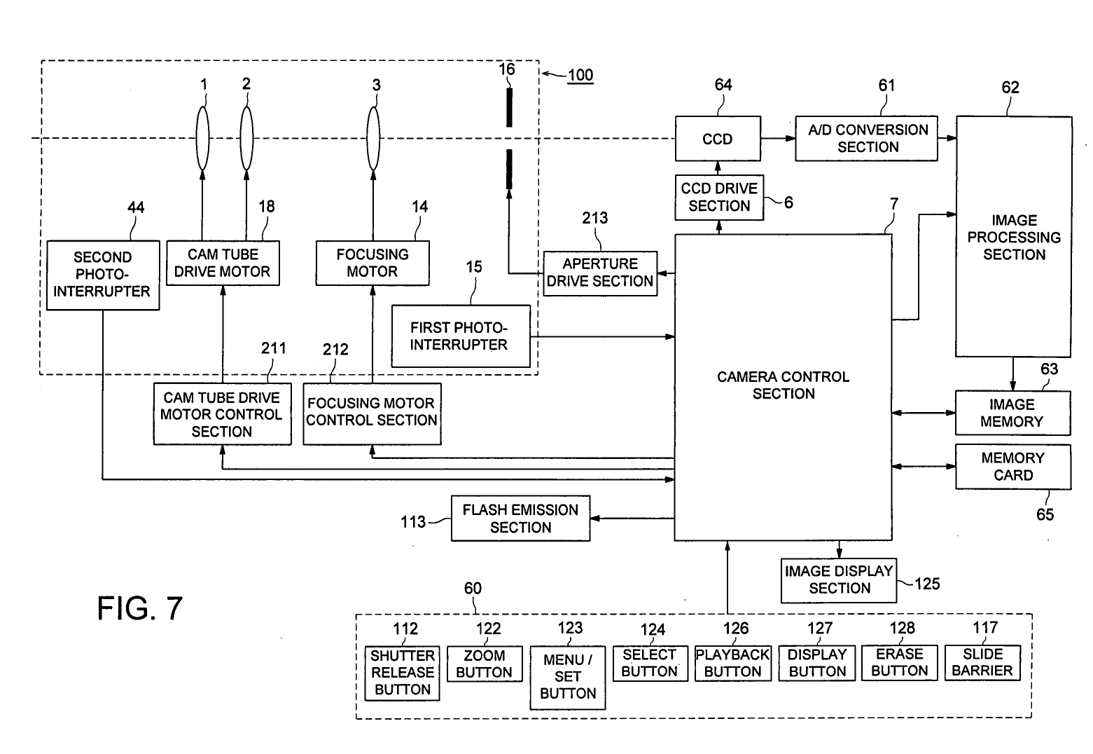

FIG. 7 is a circuit block diagram of the camera 10 that functions as the imaging apparatus according to the present invention. Like numbers are assigned here to like parts in FIG. 1 to FIG. 6(b).

The camera control section 7 which is the controller in the present preferred embodiment is configured using a CPU (Central Processing Unit) not shown in the figure, working memory, etc., the programs stored in the storage section not shown in the figure are read into the working memory not shown in the figure, and central control is carried out based on these programs of the different parts of the camera 10 including the lens barrel 100 and the lens groups of the lens barrel.

Further, the camera control section 7 receives inputs from the shutter release button 112, the zoom button 122, the Menu/Set button 123, the Select button 124, the playback button 126, the display button 127, the erase button 128, and the slide barrier 117, etc., and comprehensively controls the camera 10, and supplies power to the different sections of the camera by controlling the power supply section not shown in the figure.

The camera control section 7 controls the sequences related to photographing. The camera control section 7 controls the imaging operation of the CCD 64 via the CCD drive section 6. Further, in the present preferred embodiment, instead of the CCD it is possible to use solid state imaging device such as a CMOS sensor, CID sensor, etc. The analog signal image obtained by the CCD 64 is converted into a digital signal after noise removal in the A/D conversion section 61, and the digital signal of the image is outputted successively to the image processing section 62.

The image processing section 62 has image processing functions such as gamma correction, outline correction, image compression, etc. Even these image processings are carried out under instruction from the camera control section 7. The camera control section 7 temporarily stores the image outputted of the CCD 64 after image processing in the image memory 63, and finally records it in the memory card 65.

The camera control section 7 carries out the control of the cam tube drive motor control section 211 that drives the cam tube drive motor 18 while detecting the change in the amount of light passing through the encoder 43 using the second photo-interrupter 44, and moves the first group optical system 1 and the second group optical system 2 to the target positions.

Further, the camera control section 7 carries out control so that the focusing motor control section 212 drives the focusing motor 14 with a number of pulses corresponding to the amount of movement, and moves the third group optical system 3 to the target position.

The output of the first photo-interrupter 15 changes from ‘H’ level to ‘L’ level when the PI light cutoff section 301 cuts off the light flux between the light emitting section and light receiving section of the first photo-interrupter 15. Since the camera control section 7 is monitoring the output of the first photo-interrupter 15, it is possible to detect that PI light cutoff section 301 has cut off said light flux. The procedure from the collapsed state of the camera 10 to the imaging ready state and the procedure from the imaging ready state to the collapsed state are explained in detail later.

During photographing, the camera control section 7, based on the focus information and the exposure information obtained from the image output of the CCD 64, controls the focusing motor 14 via the focusing motor control section 212, and controls the aperture shutter unit 16 via the aperture drive section 213.

In addition, the camera control section 7 displays in the image display section 125 the live view of the images obtained by the CCD 64, or displays the images recorded in the image memory 63 in the image display section 125 as an after view, according to the setting of the display button 127, or displays in the image display section 125 the images recorded on the memory card 65 as their reproduced images.

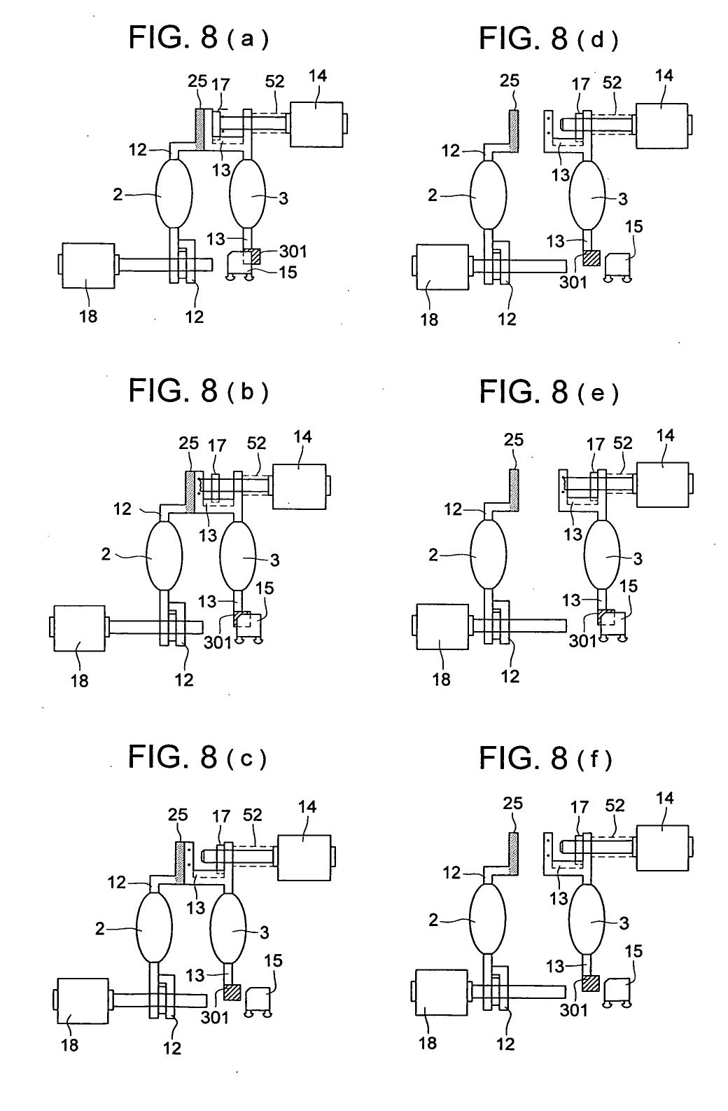

FIG. 8(a) to FIG. 8(f) are schematic diagrams for explaining the operations of the second group optical system 2 and the third group optical system 3 from the collapsed state to the imaging ready state in the preferred embodiment of the present invention. In FIG. 8(a) to FIG. 8(f), in order to simplify the explanations, the description is given below with the driving method of the second group optical system 2 being the same as the driving method of the third group optical system 3.

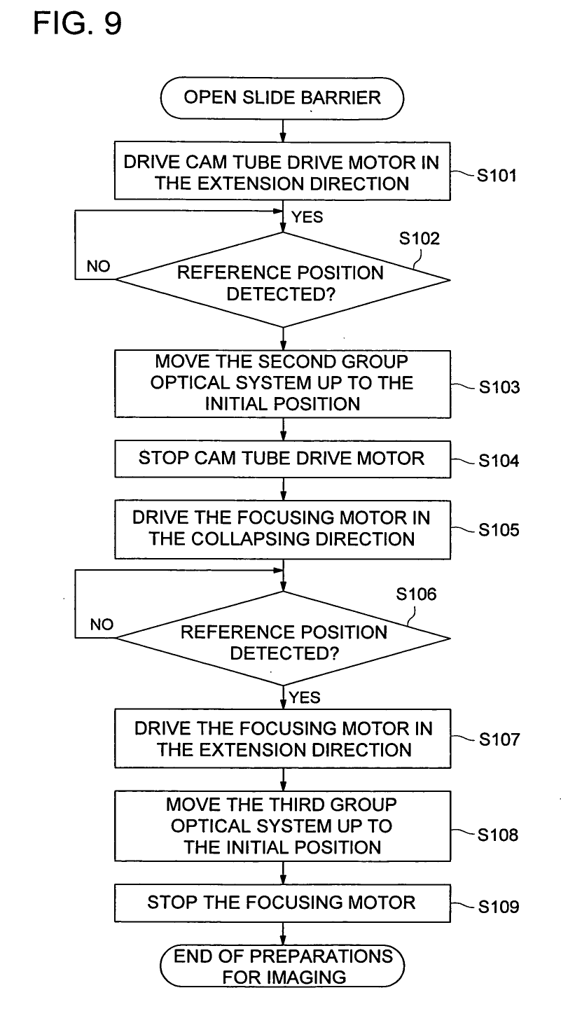

FIG. 9 is a flow chart for explaining the outline procedure of the above operations. The different parts explained with reference to FIG. 1 to FIG. 5 are shown schematically in FIG. 8(a) to FIG. 8(f), and like numbers are assigned to like parts and their explanations have been omitted here. The explanation of the operations is given below according to the flow chart of FIG. 9.

In FIG. 9, the explanations are given for the processing after the slide barrier 117 not shown in FIG. 8(a) to FIG. 8(f) is opened from the collapsed state shown in FIG. 8(a) and the power supply of the camera 10 has been switched ON.

When the power supply of the camera 10 is switched. ON, the camera control section 7, not shown in FIG. 8(a) to FIG. 8(f), controls the cam tube drive motor control section 211 while counting the output pulses of the second photo-interrupter 44 thereby rotating the cam tube drive motor 18. The cam tube drive motor 18 rotates the cam tube 22 that is coupled to it via the reduction gear column 42 which is not shown in FIG. 8, and moves the first group optical system 1 and the second group optical system 2 towards the object side until said pulses reach a prescribed number. The first group optical system 1 and the second group optical system 2 are lens groups with large amounts of movement in the present preferred embodiment.

Since the third group optical system lens frame 13 is being pushed by the bias spring 52, it moves towards the object side integrally while being in contact with the contacting section 25. In other words, the third group optical system 3 is movable in conjunction with the second group optical system 2 (Step S101). Since the PI light cutoff section 301 is provided in the third group optical system lens frame 13, the PI light cutoff section 301 moves along with the movement of the second group optical system lens frame 12. Therefore, the camera control section 7 can detect that the second group optical system lens frame 12 is at the reference position by detecting that the front edge of the PI light cutoff section 301 has cut off the light flux of the first photo-interrupter 15 and the output of the first photo-interrupter 15 has changed from the ‘H’ level to the ‘L’ level.

When the front edge of the PI light cutoff section 301 provided on the third group optical system lens frame 13 has not cut off the light flux of the first photo-interrupter 15, the operation returns to Step S101, and the camera control section 7 carries out control so that the cam tube drive motor 18 is continued to rotate (“NO” in Step S102). When the front edge of the PI light cutoff section 301 has cut off the light flux of the first photo-interrupter 15 and the position of the first photo-interrupter 15 could be detected, that is, when the camera control section 7 could detect the reference position (“YES” in Step S102), the camera control section 7 starts counting the pulses generated in the second photo-interrupter 44, not shown in FIG. 8(a) to FIG. 8(f), along with the rotation of the cam tube drive motor 18. The camera control section 7 carries out control so that the cam tube drive motor 18 rotates up to a prescribed number of pulses, moves the first group optical system 1 and the second group optical system 2 up to the initial position (Step S103), and stops the cam tube drive motor 18 (Step S104) when the movement up to the initial position has been completed.

FIG. 8(b) is the state immediately after the PI light cutoff section 301 has passed the reference position, FIG. 8(c) is an intermediate state in which the second group optical system 2 is moving to the initial position, and FIG. 8(d) is the state when the second group optical system 2 have moved up to the initial position.

Next, the camera control section 7 issues a command to the focusing motor control section 212, rotates the focusing motor and moves the third group optical system 3 towards the image side (Step S105). If the PI light cutoff section 301 attached to the third group optical system lens frame 13 has not cut off the light of the first photo-interrupter, that is, if the camera control section 7 has not detected the ‘L’ level of the output of the first photo-interrupter 15, the operation returns to Step S105 and control is carried out so that the focusing motor 14 is driven towards the image side (“NO” in Step S106). When the front edge of the PI light cutoff section 301 has cut off the light flux of the first photo-interrupter 15, that is, when the camera control section 7 detects that the output of the first photo-interrupter 15 has changed temporarily from ‘H’ to ‘L’ and then from ‘L’ to ‘H’, it is taken that the reference position has been detected, and the focusing motor 14 is stopped (“YES” in Step S106). The camera control section 7, after the reference position has been detected, drives the focusing motor 14 towards the image side by a prescribed number of pulses (Step S107), moves the third group optical system 3 up to the initial position (Step S108), and stops the focusing motor 14 (Step S109). Because of this, the first group optical system 1, the second group optical system 2, and the third group optical system 3 move up to their initial positions so that the state is one in which the preparations for image have been completed at all times.

FIG. 8(d) shows the state when the second group optical system 2 have moved up to the initial position, FIG. 8(e) shows the state when position of said front edge of the PI light cutoff section 301 has been detected, and FIG. 8(f) shows the preparations for imaging complete state each of the group optical systems have moved to their initial positions.

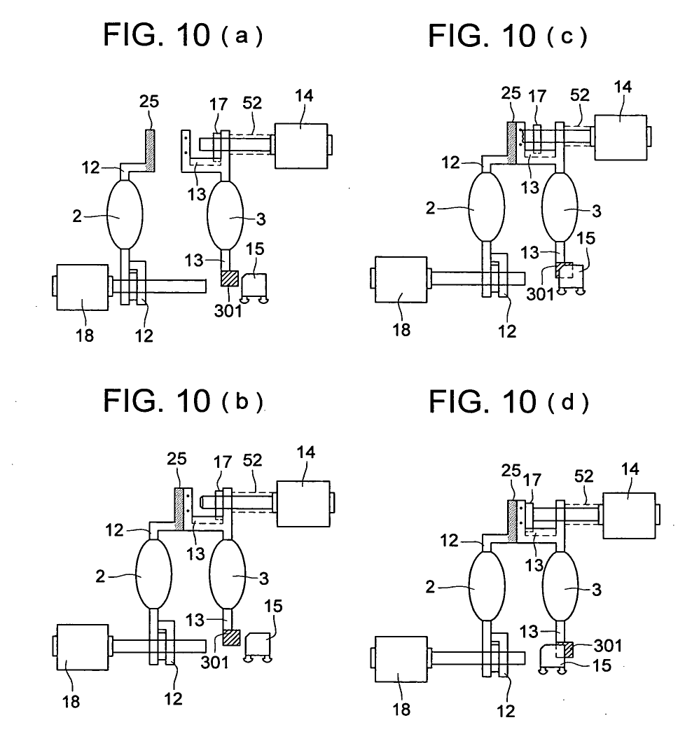

FIG. 10(a) to FIG. 10(d) are schematic diagrams for explaining the operations of the second group optical system 2 and the third group optical system 3 from the imaging ready state to the collapsed state in the present preferred embodiment of the present invention. In FIG. 10(a) to FIG. 10(d), in order to simplify the explanations, the description is given below with the driving method of the second group optical system 2 being the same as the driving method of the third group optical system 3.

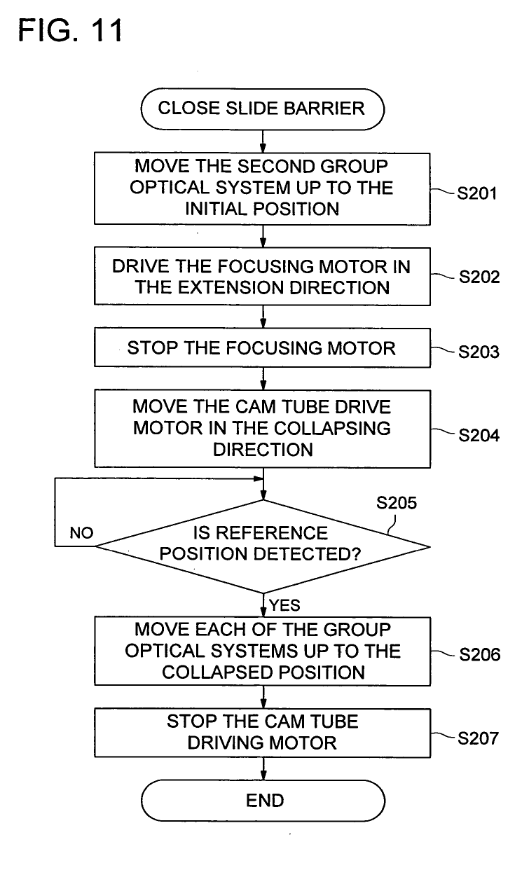

FIG. 11 is a flow chart for explaining the outline procedure of the above operations. In FIG. 10(a) to FIG. 10(d) also, similar to that in FIG. 8(a) to FIG. 8(f), like numbers are assigned to like parts and their explanations have been omitted here. The explanation of the operations is given below according to the flow chart of FIG. 11.

In FIG. 11, explanations are given about the operations after the slide barrier 117, not shown in FIG. 10(a) to FIG. 10(d), has been closed from the imaging ready state. Here, although explanations will be given in the present preferred embodiment so that the lens barrel gets collapsed in coordination with the slide barrier 117, it is also possible to start the collapsing operations in coordination with the pressing of a switch or button such as the power supply switch.

When the slide barrier is closed, the camera control section 7 drives the cam tube 22 via the cam tube drive motor 18 for a prescribed number of pulses generated by the second photo-interrupter 44, and moves the second group optical system 2 to its initial position (Step S201). However, the camera control section 7 knows the position of the second group optical system 2 from the reference position since it moves the second group optical system 2 while counting the number of pulses generated by the second photo-interrupter 44 even during photographing (imaging).

Next, the camera control section 7 rotates the focusing motor 14 towards the object side and moves the third group optical system 3 (Step S202). The camera control section 7 causes the third group optical system 3 to move up to the prescribed position indicated in FIG. 10(a) and to stop there (Step S203).

Next, the camera control section 7 drives the cam tube drive motor 18 and starts moving the first group optical system 1 and the second group optical system 2, not shown in FIG. 10(a) to FIG. 10(d), towards the image side (Step S204). As is shown in FIG. 10(b), the contacting section 25 comes into contact with the third group optical system lens frame 13, and, the first group optical system 1 and the second group optical system 2 move towards the image side opposing the force of the bias spring 52.

When the front edge of the PI light cutoff section 301 has not passed the light flux of the first photo-interrupter 15, that is, when the camera control section 7 has not detected that the output of the first photo-interrupter 15 has changed temporarily from ‘H’ to ‘L’ and then from ‘L’ to ‘H’, the operation returns to Step S205 and the cam tube drive motor 18 is continued to be drive as it is (“NO” in Step S205). After the PI light cutoff section 301 has cut off the light flux of the first photo-interrupter 15, when said front edge of the PI light cutoff section 301 has passed beyond the light flux, that is, when the camera control section 7 detects the reference position because the output of the first photo-interrupter 15 has first changed temporarily from ‘H’ to ‘L’ and then from ‘L’ to ‘H’ (“YES” in Step S205), the camera control section 7 counts the number of pulses from the second photo-interrupter 44, not shown in FIG. 10(a) to FIG. 10(d), and drives the cam tube drive motor 18 until a prescribed number of pulses is reached (Step S206). When said prescribed number of pulses is reached, the camera control section 7 stops the cam tube drive motor 18 (Step S207), whereby the collapsing is completed. In other words, since the camera control section 7 drives the cam tube drive motor 18 by a prescribed amount after the reference position is detected, it is possible to definitely move the first group optical system 1, the second group optical system 2, and the third group optical system 3 that move in an interlinked manner up to the prescribed collapsed position.

In the above manner, at the time of detecting the reference positions of each of the lens groups in the present preferred embodiment, since the drive section driving the respective lens groups detect by moving a single detected member, it is possible to provide a lens barrel and an imaging apparatus that can detect definitely the positions of a plurality of lens groups, does not require high accuracy components, is small in size, has low power consumption, has a high reliability, and is inexpensive.

According to another aspect of the preferred embodiment of the present invention, at the time of detecting the reference position of each of the lens groups, since the drive section driving the respective lens group detects by moving a single detected member, it is possible to definitely detect the positions of the different lens groups and to provide a lens barrel with a high reliability.

According to yet another aspect of the preferred embodiment of the present invention, since the detected member is attached to the lens group that is closest to the collapsed side, it is possible to provide a lens barrel in which the formation of grooves is simple, the number of parts is small and the size is small.

According to yet another aspect of the preferred embodiment of the present invention, since a bias pressure member is attached to the lens group to which said member to be detected is attached, at the time of detecting that a lens group to which said member to be detected is not attached is at the reference position, said lens group to which said member to be detected is attached is moved in contact with the lens group to which said member to be detected is not attached because of the bias pressure member, it is possible to detect the position definitely and to provide a lens barrel whose construction is simple.

According to yet another aspect of the preferred embodiment of the present invention, it is possible to provide a lens barrel having a simple construction and with smaller number of components, since the drive section of the lens group to which said member to be detected is attached is a pulse motor, and after the detection of the reference position, it is possible to detect the current position of the lens group to which said member to be detected is attached from the number of pulses given to the pulse motor.

According to yet another aspect of the preferred embodiment of the present invention, it is possible to provide an imaging apparatus that can detect the reference position easily and that has a small starting time, since the lens group with a large amount of movement is moved at first during starting.

According to yet another aspect of the preferred embodiment of the present invention, it is possible to provide a small-sized, high reliability imaging apparatus that can definitely detect in a short time the collapsed position, since, after the lens group to which said member to be detected is attached and the lens group to which said member to be detected is not attached are moved to a prescribed position towards the object side, the lens group to which said member to be detected is not attached is moved towards the image side, the reference position is detected using said member to be detected, and the collapsed state is achieved by moving the lens group to which said member to be detected is not attached by a prescribed amount from the reference position towards the image side.

However, although the example of a digital camera as an imaging apparatus was given here as the present preferred embodiment, the lens barrel of the present preferred embodiment can also be applied to film cameras, mobile telephones with digital camera functions, or to video cameras, etc. Further, the configuration of the lens barrel need not be limited to the collapsible method, but can also be one in which the overall length of the lens barrel does not change.

What is claimed is:

1. A lens barrel, comprising:
a first lens group which is movable;
a first driving device for moving the first lens group along an optical axis;
a second lens group which is movable;
a second driving device for moving the second lens group along the optical axis;
a member to be detected which is fixed on the second lens group;
a detector for detecting the member to be detected; and
an interlock mechanism for interlocking the second lens group with a movement of the fist lens group.

2. The lens barrel of claim 1, wherein the second lens group lies nearest to an imaging plane of a plurality of lens groups included in the lens barrel.

3. The lens barrel of claim 1, wherein the interlock mechanism makes the second lens group contact to the first lens group by a biasing force.

4. The lens barrel of claim 1, wherein the second driving device includes a pulse motor.

5. The lens barrel of claim 1, wherein the first driving device drives the first lens group based on a detection result of the detector.

6. An image pickup apparatus, comprising:
an imaging device;
a lens barrel for projecting an optical image on the imaging device; and
an controller which controls the imaging device and the lens barrel,
wherein the lens barrel comprises:
a first lens group which is movable;
a first driving device for moving the first lens group along an optical axis;
a second lens group which is movable;
a second driving device for moving the second lens group along the optical axis;
a member to be detected which is fixed on the second lens group;
a detector for detecting the member to be detected; and
an interlock mechanism for interlocking the second lens group with a movement of the first lens group.

7. The image pickup apparatus of claim 6, wherein the second lens group lies nearest to an imaging plane of a plurality of lens groups included in the lens barrel.

8. The image pickup apparatus of claim 6, wherein the interlock mechanism makes the second lens group contact to the first lens group by a biasing force

9. The image pickup apparatus of claim 6, wherein the second driving device includes a pulse motor.

10. The image pickup apparatus of claim 6, wherein the controller controls the first and second driving devices based on a detection result of the detector.

11. The image pickup apparatus of claim 6, wherein the controller moves each lens group of the lens barrel to a predetermined position on startup of the image pickup apparatus.

12. The image pickup apparatus of claim 11, wherein the controller moves sooner the lens group whose travel distance to the predetermined position is large than the lens group whose travel distance to the predetermined position is small at startup of the image pickup apparatus.

13. The image pickup apparatus of claim 6, wherein the lens barrel is collapsible.

14. The image pickup apparatus of claim 13, wherein the controller, at the time of collapsing the lens barrel, controls the first driving device to drive the first and second lens groups for the imaging plane by a driving force of the first driving device after the controller controls the first and second driving devices to drive the first and second lens groups to the predetermined position.
